(19) United States
(12) Patent Application Publication
(10) Pub. No.: US 2007/0268966 A1
(43) Pub. Date: Nov. 22, 2007

(54) Apparatus and method for retrieving video

(75) Inventor: Myoung-ho Kim, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/590,822

(22) Filed: Nov. 1, 2006

(30) Foreign Application Priority Data
May 17, 2006 (KR) 2006-44416

(51) Int. Cl. H04N 7/12; H04N 11/04

(52) U.S. Cl. 375/240.08; 375/240.2

(57) ABSTRACT

A video-retrieval apparatus includes an input unit that receives a sample video extracted from a predetermined video; an edge-histogram-generation unit that generates an edge histogram according to the type of edges that are included in the discrete cosine transform (DCT) blocks by frames that include a plurality of sub-areas consisting of a plurality of DCT blocks; a key-frame-selection unit that selects a key frame from the sample video based on the edge histogram; and a video-retrieval unit that retrieves a video that matches the sample video by measuring the similarity rate between the selected key frame and the key frame selected from the video in storage.

### CROSS-REFERENCE TO RELATED APPLICATION

This application claims the benefit of Korean Application No. 2006-44416, filed May 17, 2006 in the Korean Intellectual Property Office, the disclosure of which is incorporated herein by reference.

### BACKGROUND OF THE INVENTION

1. Field of the Invention

Aspects of the invention relate to methods and apparatuses for retrieving video. More particularly, aspects of the present invention relate to an apparatus and method for retrieving video, in which a user can retrieve video at high speed.

2. Description of the Related Art

As Internet and multimedia technologies become developed, multimedia data is rapidly increasing. As the supply of multimedia data increases, research on technologies for retrieving information becomes more important. There are two major ways of retrieving multimedia content: notes-based retrieval and content-based retrieval. The notes-based retrieval is a method that describes each image manually, and mainly uses a key word retrieval method. This method can be subjective and requires significant amounts of time because key words need to be made by people, which is not optimal.

The content-based retrieval has been developed to overcome the disadvantages of notes-based retrieval. This method automatically separates content components from multimedia content, automatically extracts features of the separated components, generates a database of the features, and performs retrieval. The content-based retrieval performs retrieval using only visual features of multimedia content regardless of key words. For example, in the case where content-based image retrieval is performed, similar images are retrieved by calculating the similarity rate between a query image and a target image using color, shape, texture and others of components included in the image.

In the case of a video-retrieval method among conventional content-based retrieval methods, each set of feature information is extracted from videos in storage, the database of the extracted information is made, the feature information is extracted from a query video, and the database of the extracted information is made. Then, by measuring the similarity rate of the databases, a video similar to the query video is retrieved among videos in storage. Some examples of such video-retrieval methods are Edge Matching Image (EMI) and Group-of-Frames-Group-of-Pictures (GoF-GoP).

FIG. 1 is a flow chart illustrating the process of extracting feature information in a video-retrieval method by the conventional EMI technique. First, all frames of a video in storage are decoded S110. Specifically, after all frames of the video are entropy-decoded S110, an inverse quantization is performed S112. When the inverse quantization is completed, a discrete cosine transform (DCT) coefficient is generated by 8×8 block units. When the DTC coefficients pass the IDCT process S113, a reconstructed image is generated.

When frames are reconstructed, a key frame is retrieved among reconstructed frames. The key frame refers to a frame that represents one image, and one shot can be defined as an area from a spot where a scene change has occurred to a spot where the next scene change occurs. When the key frame is retrieved, the feature information (e.g., edge information) is extracted from the retrieved key frame by performing a filtering S120. The extracted edge information is used to retrieve a target video similar to a query video. That is, the similarity rate is measured by comparing the edge information of the query video and the edge information of videos in storage. Among videos in storage, the video, which has edge information that is very similar to the edge information of the query video, is selected as the target data S130.

In the above-described video-retrieval method, in order to extract the key frame, the color histogram and the accumulated color histogram between the current frame and the previous frame are used. Hence, in order to extract the key frame, all frames of the encoded video should be decoded. However, the decoding of all frames increases the time needed to retrieve the video. Further, the filtering process for extracting feature information necessary for measuring the similarity rate of the query video and the target video requires a great deal of calculation, and thus increases the time needed to retrieve the video. Hence, there is a need for a video-retrieval technology that retrieves video at a high speed by reducing the number of calculations.

### SUMMARY OF THE INVENTION

An aspect of the present invention provides a video-retrieval apparatus that retrieves video at a high speed.

Another aspect of the present invention provides a video-retrieval method that retrieves video at a high speed.

According to an exemplary embodiment of the present invention, there is provided a video-retrieval apparatus including an input unit that receives a sample video extracted from a predetermined video; an edge-histogram-generation unit that generates an edge histogram according to the type of edges that are included in the discrete cosine transform (DCT) blocks by frames that include a plurality of sub-areas consisting of a plurality of DCT blocks; a key-frame-selection unit that selects a first key frame from the sample video based on the edge histogram; and a video-retrieval unit that retrieves a video that matches the sample video by measuring the similarity rate between the first key frame and a second key frame selected from a video in storage.

According to an exemplary embodiment of the present invention, there is provided a video-retrieval method including receiving a sample video extracted from a predetermined video; generating an edge histogram according to the type of edges that are included in the DCT blocks by frames that include a plurality of sub-areas consisting of a plurality of DCT blocks; selecting a first key frame from the sample video based on the edge histogram; and retrieving a video that matches the sample video by measuring the similarity rate between the first key frame and a second key frame selected from a video in storage.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart illustrating a conventional video-retrieval method according to a conventional art;

FIG. 2 is a block diagram illustrating the structure of a video-retrieval apparatus according to an exemplary embodiment of the present invention;

FIG. 3 illustrates the partition of an I frame into a plurality of sub-areas according to an exemplary embodiment of the present invention;

FIG. 4 illustrates the partition of a discrete cosine transform (DCT) block according to an exemplary embodiment of the present invention;

FIG. 5 illustrates a local edge histogram according to an exemplary embodiment of the present invention;

FIGS. 6A through 6B illustrate the partition of a semi-global area according to an exemplary embodiment of the present invention;

FIG. 7 is a flow chart illustrating a video-retrieval method according to an exemplary embodiment of the present invention;

FIG. 8 is a flow chart illustrating step S730 of FIG. 7 in more detail, which generates an edge histogram according to an aspect of the present invention; and

FIG. 9 is a flow chart illustrating step S750 of FIG. 7 in more detail, which retrieves a video according to an aspect of the present invention.

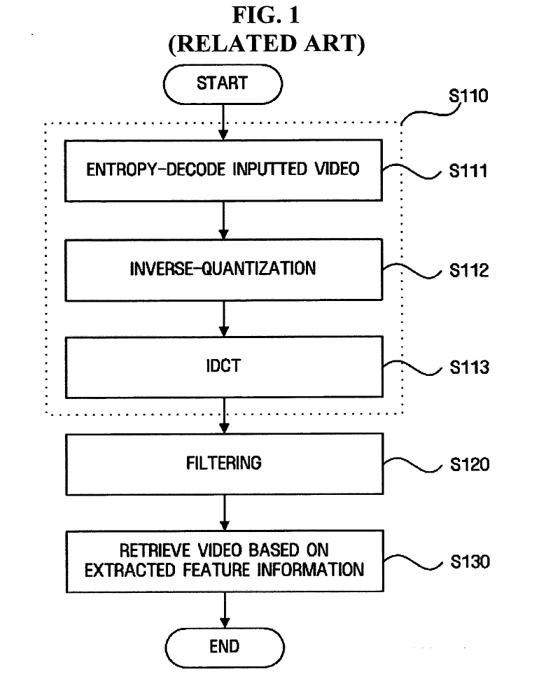

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An aspect of the present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, and/or other programmable data processing apparatus to produce a machine or system of machines, such that the instructions, which execute via the processor of the computer or other programmable data processing apparatus, create means for implementing the functions specified in the flowchart block or blocks. However, the invention is not limited thereto.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus (or combination thereof) to cause a series of operational steps to be performed in the computer or other programmable apparatus to produce a computer implemented process such that the instructions that execute in the computer or other programmable apparatus provide steps for implementing the functions specified in the flowchart block or blocks.

Moreover, each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

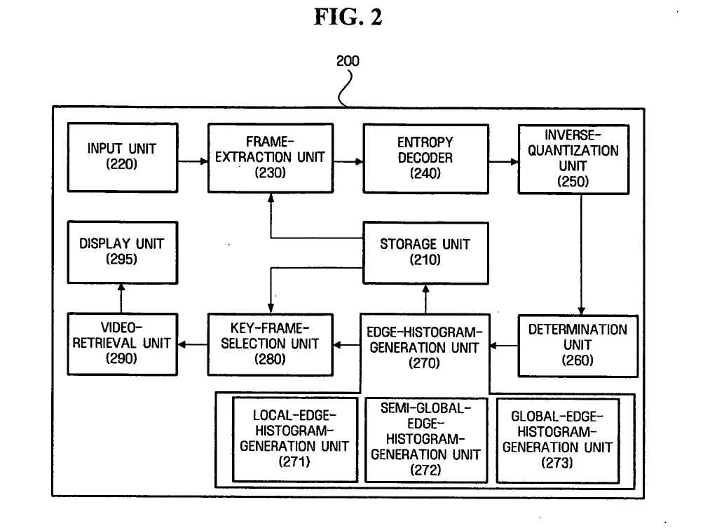

FIG. 2 is a block diagram illustrating the structure of a video-retrieval apparatus 200 according to an exemplary embodiment of the present invention. The illustrated video-retrieval apparatus 200 includes a storage unit 210, an input unit 220, a frame-detecting unit 230, an entropy decoder 240, an inverse-quantization unit 250, a determination unit 260, a edge-histogram-generation unit 270, a key-frame-selection unit 280, a video-retrieval unit 290, and a display unit 295. However, it is understood that one or more of the units need not be used in all aspects the units can be combined as in the case of a touch screen display, and the units can be only connected to the apparatus 200 as opposed to included in the apparatus 200. While not required in all aspects, the apparatus 200 could be implemented as a server which compares stored videos with videos available on other servers to determine the location of and/or extent to which copies of the stored videos have been distributed, to determine like videos for use in categorization, or to find a remainder of a larger video when only a portion of the video is otherwise available.

The storage unit 210 stores encoded video, and stores data generated by each component of the video-retrieval apparatus 200. For example, the storage unit 210 stores the edge histogram on each I frame generated by the edge-histogram-generation unit 270. Such a storage unit 210 can be implemented by a nonvolatile memory element such as a cache, ROM, PROM, EPROM, EEPROM, or flash memory, by a volatile memory element such as RAM, or by a storage medium such as a HDD or optical medium, but it is not limited to this. The storage unit 210 can be detachable in addition to or instead of internal storage. However, it is understood that the storage unit 210 need not store the edge histogram for each stored video in all aspects of the invention.

The input unit 220 receives a sample video extracted from a predetermined video (i.e., a query video) which includes at least one I frame. The frame-detection unit 230 detects an I frame from frames included in the query video or the stored video stored in the storage unit 210. The detected I frame is provided to the entropy decoder 240. The entropy decoder 240 entropy-decodes the I frame provided from the frame-detection unit 230. The entropy-decoded I frame is provided to the inverse-quantization unit 250. While not required in all aspects, the input unit 220 can receive the sample video using a drive reading a medium (such as an optical storage medium or a magnetic medium), from a camera, or through a network from a remote medium.

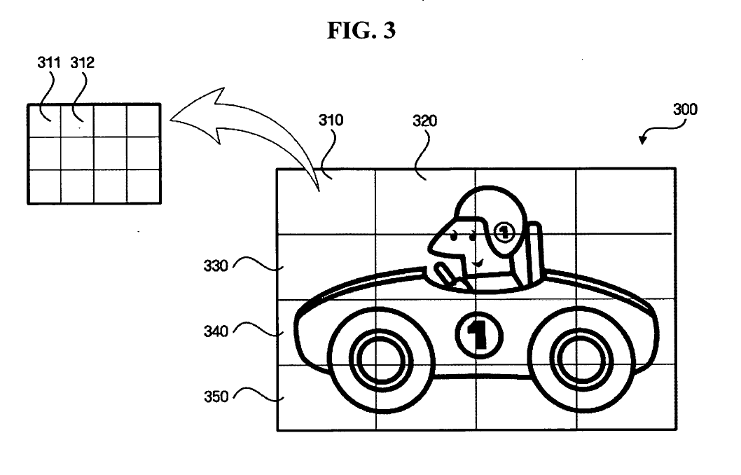

The inverse-quantization unit 250 inverse-quantizes the entropy-decoded frame I. As shown in FIG. 3, the inverse-quantized I frame 300 can be partitioned into 16 sub-areas. Further, each sub-area, such as sub-area 310 can be partitioned into a plurality of 8×8 discrete-cosine-transform (DCT) blocks (such as blocks 311, 312 shown in a corner portion of the 8×8 for the sub-area 310). Each DCT block has a DCT coefficient made of a linear combination of all pixels within the block using the equation 1. However, it is understood that other numbers of areas can be implemented, with equation 1 being suitably adjusted.

$$A {C}_{u , v} = \frac{1}{4} {C}_{u} {C}_{v} {\sum }_{i = 0}^{7} {\sum }_{j = 0}^{7} cos \frac{( 2 i + 1 ) u π}{16} cos \frac{( 2 j + 1 ) v π}{16} f ( i , j ) \\ {C}_{u} , {C}_{V} = [ \begin{matrix}\sqrt{\frac{1}{2}} , & for u , v = 0 \\ 1 , & otherwise\end{matrix} \qquad EQUATION 1$$

Among DCT coefficients on a certain DCT block, AC_{0, 0} is a coefficient of the DC element, and refers to the average brightness of the DCT block. The remaining coefficients AC_{0, 1} to AC_{7, 7} are AC elements that have a certain direction and a certain rate of change, and reflect the change in the gray level value. F(i,j) represents a pixel value at location i,j of the DCT block. AC_{0, 1} depends on the difference in the horizontal direction between the left side and the right side of the DCT block in the space area. In comparison, AC_{1, 0} depends on the difference in the vertical direction between the upper side and the lower side of the DCT block in the space area. In other words, the coefficient AC_{0, 1} represents the edge element in the horizontal direction that is included in the DCT block, and the coefficient AC_{1, 0} represents the edge element in the vertical direction that is included in the DCT block.

Further, the determination unit 260 determines whether each DCT block is an edge area based on the DCT coefficient of each DCT block. Specifically, the determination unit 260 determines whether each DCT block includes an edge (i.e., an edge of an image within the DCT block). Here, the variance value of pixels values of each DCT block can be used as a basis for determining the edge area. The variance value in the DCT area can be acquired from the sum total of the squares of AC coefficients exempting DC elements. In other words, in the case where the variance value of a predetermined DCT block is greater than a first critical value, the determination unit 260 determines that the DCT block includes an edge.

In contrast, in the case where the variance value is less than the first critical value, the determination unit 260 determines that the DCT block does not include the edge (i.e., the determination unit 260 determines that the DCT block is a smooth area). In the case where the DCT block is a smooth area, the determination unit 260 determines whether the next DCT block is an edge area.

As a result, in the case where the DCT block is an edge area (i.e., a portion of the frame having an edge of an image), the determination unit 260 determines the type of the edge that the DCT block includes. First, the determination unit 260 determines whether the edge included in the DCT block is non-directional or directional. Some examples of the directional edge are a horizontal edge, a 45°-direction edge, a vertical edge, and a 135°-direction edge. The determination unit 260 can determine whether each DCT block is a non-directional edge based on the strength of the AC_{0, 1} and AC_{1, 0} coefficients. In other words, where the strength of the edge is less than a second critical value, the determination unit 260 determines that the type of the edge included in the DCT block is a non-directional edge.

Where the edge included in the DCT block is a directional edge, the determination unit 260 determines the type of the directional edge. Here, the type of the directional edge can be determined based on the rate of AC_{0, 1} and AC_{1, 0} among AC coefficients of each DCT block. R1 and R2, which represent the rate of AC_{0, 1} and AC_{1, 0}, can be defined by the equation 2 and equation 3.

$$\begin{matrix}R 1 = \vert \frac{A {C}_{0 , 1}}{A {C}_{1 , 0}} \vert & EQUATION 2 \\ R 2 = \vert \frac{A {C}_{1 , 0}}{A {C}_{0 , 1}} \vert & EQUATION 3\end{matrix}$$

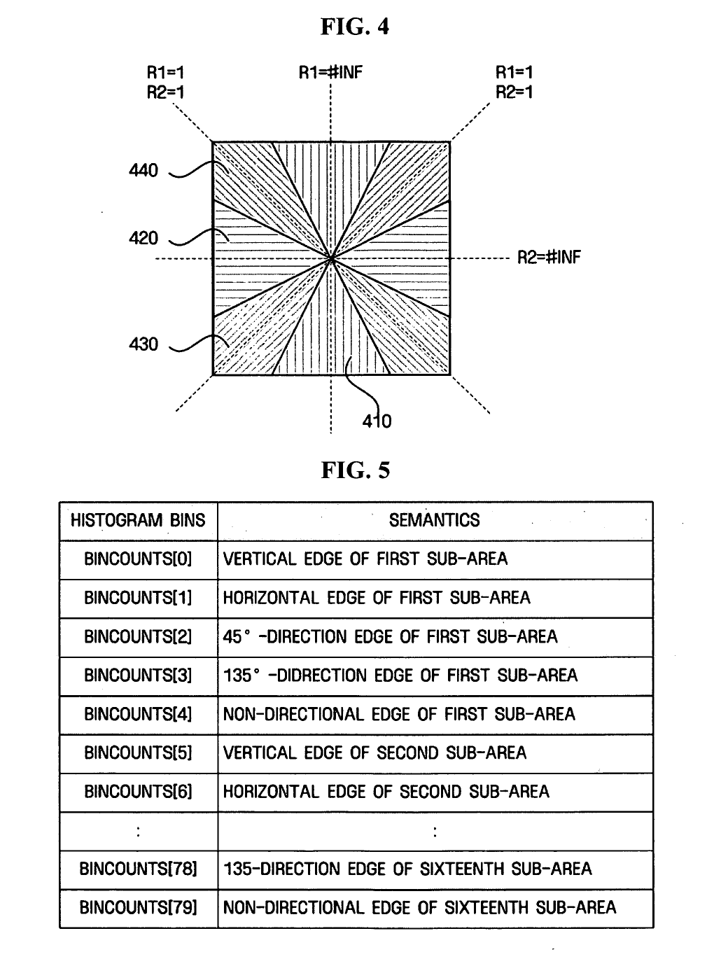

According to an aspect of the invention, each DCT block is partitioned into a first area 410, a second area 420, a third area 430, and a fourth area 440 depending on the values of the defined R1 and R2, as illustrated in FIG. 4. Here, the determination unit 260 detects the area where the value of the rate of AC_{0, 1} and AC_{1, 0} is included among AC coefficients of the DCT block, and thus determines the type of edge that is included in the DCT block.

For example, in the case where the rate of the two coefficients is included in the first area 410 (i.e., R1 is close to infinity and R2 is not close), the determination unit 260 determines that the DCT block includes the vertical edge as shown in FIG. 4. In the case where the rate of the two coefficients is included in the second area 420 (i.e., R2 is close to infinity and R1 is not close), it can be determined that the DCT block includes a horizontal edge as shown in FIG. 4. Additionally, in the case where the rate of AC_{0, 1} and AC_{0, 1} is close to infinity, R1 and R2 are close to 1, and the determination unit 260 determines that the DCT block has a 45°-direction edge or a 135°-direction edge as shown in FIG. 4. Here, the determination unit 260 determines that the DCT block has a 45°-direction edge if the signs of the two AC coefficients are the same, and determines that the DCT block has a 135°-direction edge if the signs of the two coefficients are different.

The edge-histogram-generation unit 270 generates an edge histogram that includes the edge distribution information on an I frame. Specifically, the edge-histogram-generation unit 270 generates a local edge histogram based on the result of the determination of the determination unit 260, and then generates a global edge histogram and a semi-global edge histogram, respectively, based on the local edge histogram. For this, the edge-histogram-generation unit 270 includes a local-edge-histogram-generation unit 271, a global-edge-histogram-generation unit 273, and a semi-global edge-histogram-generation unit 272.

The local-edge-histogram-generation unit 271 generates a local edge histogram based on the result of the determination of the determination unit 260. Here, the local edge histogram indicates the distribution information of a certain I frame by sub-areas. The local edge histogram is described in more detail with reference to FIG. 5.

FIG. 5 illustrates a local edge histogram. Referring to FIG. 5 and FIG. 3, the local edge histogram of one I frame can include a total of 80 bins. It is because the I frame 300 is partitioned into 16 sub-areas, and bins for 5 types of edge elements are generated for each sub-area. In the I frame, which has been partitioned into 16 sub-areas, if the determination unit 260 determines the type of the edge included in the first DCT block of a first sub-area 310 of frame 300, the local-edge-histogram-generation unit 271 increases the value of the bin corresponding to the result of the determination among five bins of the first sub-area 310. For example, in the case where it is determined that a first DCT block 311 of the first sub-area 310 includes a vertical edge, the local-edge-histogram-generation unit 271 increases by 1 the value of the bin that represents the vertical edge information among five bins of the first sub-area 310. Then, in the case where it is determined that a second DCT block 312 of the first sub-area 310 includes the horizontal edge, the local-edge-histogram-generation unit 271 increases by 1 the value of the bin that represents the horizontal edge information among five bins of the first sub-area 310.

In the same manner, if the edge histogram of the first sub-area 310 is completed, the local-edge-histogram-generation unit 271 performs this process on each sub-area (such as second sub-area 320) of the I frame 300 in order to complete the local edge histogram of the I frame.

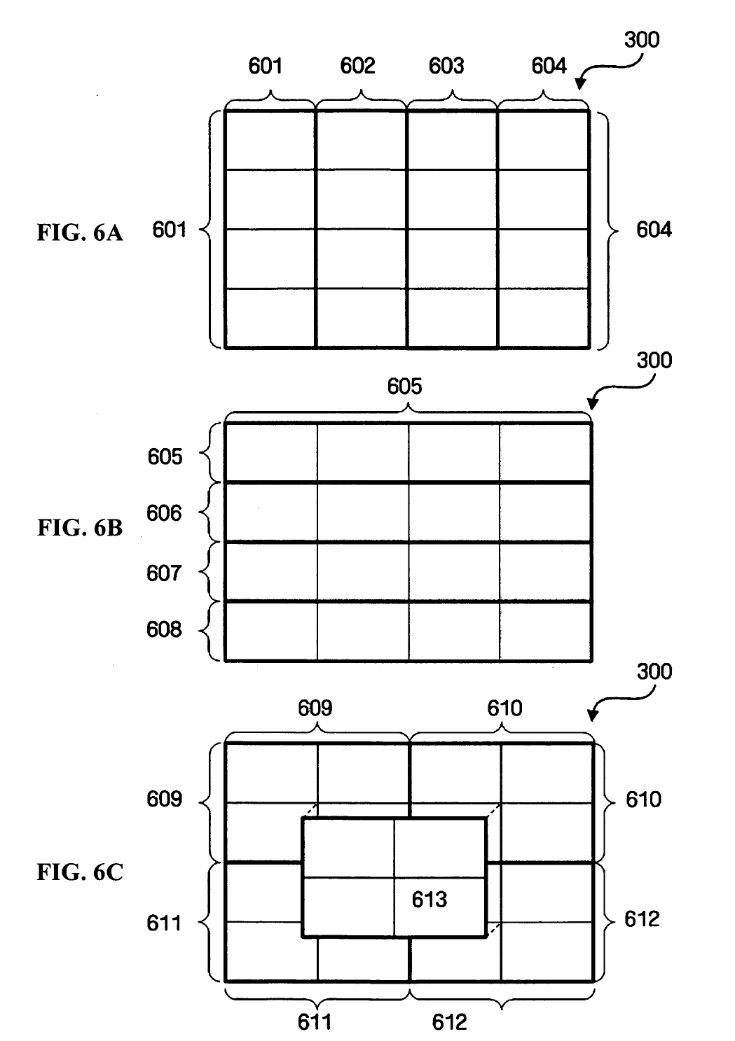

The semi-global edge-histogram-generation unit 272 generates a semi-global edge histogram of the I frame based on the local edge histogram. Here, the semi-global edge histogram represents the edge distribution information of the I frame by semi-global areas. The semi-global area can be formed by grouping at least two sub-areas among 16 sub-areas. For example, as illustrated in FIGS. 6A and 6B, 16 4×4 sub-areas are grouped in line direction and in row direction, respectively. Thus, a first semi-global area 601 through an eighth semi-global area 608 are formed.

Then, the total area is grouped in 2×2 type as shown in FIG. 6C, and a ninth semi-global area 609 through a thirteenth semi-global area 613 are formed. As such, a total of 13 semi-global areas 601 through 613 are formed. Here, the semi-global edge histogram includes a total of 65 bins. It is because bins corresponding to the vertical, horizontal, 45°, 135°, and non-directional edge elements, are generated for each semi-global area. However, it is understood that other numbers of bins and/or sub-areas can be used.

While not required in all aspects, the semi-global edge histogram can be acquired by the sum total of values of bins that represent the same edge element among bins of sub-areas included in the same semi-global area in the local edge histogram. For example, the sum of bins that represent the vertical direction among 5 bins for the first, fifth, ninth and thirteenth sub-areas 310, 330, 340, 350 is recorded in the bin that represents the vertical direction among five bins on the first semi-global area 601. In the same manner, the sum of bins that represent the horizontal direction among 5 bins for the first, fifth, ninth and thirteenth sub-areas 310, 330, 340, 350 is recorded in the bin that represents the horizontal direction among five bins on the first semi-global area 601.

Further, the global-edge-histogram-generation unit 273 generates the global edge histogram that represents the edge distribution information on the total area of the frame I. The global edge histogram includes five bins that correspond to the vertical, horizontal, 45-degree, 135-degree, and non-directional edge elements. Such a global edge histogram can be generated based on the local edge histogram. Specifically, the sum of bins that represent the vertical edge element is recorded in the bin that represents the vertical edge element among the global edge histogram. Likewise, the sum of bins that represents the horizontal edge element among the local edge histogram is recorded in the bin that represents the horizontal edge element among the global edge histogram.

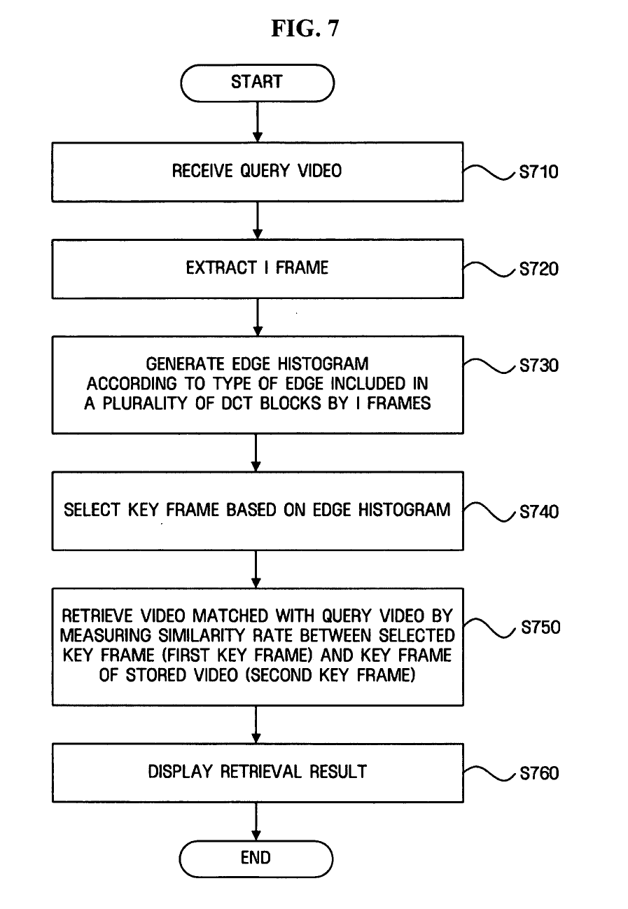

Among the aforementioned edge-histogram-generation process, the local-edge-histogram-generation process is repeatedly performed on all I frames. While not required, it is preferable that the edge information on all I frames of the stored video is generated in advance (i.e., before the query video is inputted) and the edge-histogram bin on each I frame and are stored in the aforementioned storage unit 210 as shown in FIG. 7. As such, the stored video would be processed by units 230, 240, 260, 270 in advance. However, it is understood that the stored video can have the key frames and/or edge histograms processed by other devices and loaded into the storage unit 210 and/or accessed across a network.

Referring to FIG. 2, the key-frame-selection unit 280 selects a key frame based on the local edge histogram generated by the edge-histogram-generation unit 270 for the query video and the stored video. For this, first, the key-frame-selection unit 280 generates the edge histogram bin difference (EHBD) between the current I frame and the previous I frame. In the case where the generated result is greater than the third critical value, the key-frame-selection unit 280 determines that the edge change between two I frames is great, and thus specifies the current I frame as the key frame. Here, the EHBD is acquired by the sum total of differences between the local edge histogram of the current I frame and the edge histogram bin at the same position in the local edge histogram of the previous I frame.

The video-retrieval unit 290 retrieves the video that matches the query video by measuring the similarity rate between a key frame (hereinafter, called a “first key frame”) extracted from the query video and a key frame (hereinafter, called a “second key frame”) extracted from the stored video. Here, the Hausdorff distance between the first key frame and the second key frame can be used as a basis for measuring the similarity rate. Using the Hausdorff distance between the first key frame and the second key frames for the stored videos in the storage unit 210, the one of the stored videos that has the smallest value can be specified as the video that matches the query video.

The Hausdorff distance can be acquired by the sum total of differential values of the bin at the same position, respectively, in each edge histogram on the first key frame and the second key frame. Preferably and while not required in all aspects, the differential value of the bin is produced by edge histograms of the same type. Specifically, first, the video-retrieval unit 290 produces differential values on the bin at the same position, respectively, in the local edge histogram of the first key frame and the second key frame. Here, a total of 80 differential values are produced, and the video-retrieval unit 290 produces a first result value that is the sum total of 80 differential values. Then, the video-retrieval unit 290 produces the differential values of the bin at the same position in the global edge histogram of the first key frame and the second key frame. Here, a total of 5 differential values are produced, and the video-retrieval unit 290 produces a second result value that is the sum total of 5 differential values. Then, the video-retrieval unit 290 produces the differential values of the bin at the same position, respectively, in the semi-global edge histogram of the first key frame and the second key frame. Here, total 65 differential values are produced, and the video-retrieval unit 290 produces a third result value that is the sum total of 65 differential values. Then, the video-retrieval unit 290 produces a Hausdorff distance that is the sum total of the first result value, the second result value and the third result value. Further, the global histogram includes less number of bins compared to the local histogram and the semi-global histogram, and thus when summing up each result value, a predetermined weight can be applied to the second result value.

The video-retrieval unit 290 repeats the aforementioned process on a plurality of second key frames which the key frame extraction unit 280 obtains from the stored videos in the storage unit 210, and identifies the one of the stored videos that includes the second key frame having the lowest Hausdorff distance as the result of the retrieval. The display unit 295 displays the result of the command-handling in a visible form. For example, the display unit 295 displays the stored video retrieved by the video-retrieval unit 290.

A video-retrieval method according to an exemplary embodiment of the present invention is described with reference to FIGS. 7 to 9 in the following. FIG. 7 is a flow chart illustrating a video-retrieval method according to an exemplary embodiment of the present invention. First, When a query video is received (i.e., input) through the input unit 220 S710, the frame-detection unit 230 detects an I frame among frames included in the query video S720. The detected I frame is entropy-decoded by the entropy-decoder 240, and is then inverse-quantized by the inverse-quantization unit 250. If the inverse-quantization process is completed, the I frame can be partitioned into a plurality of sub-areas having corresponding DCT blocks (i.e., 16 sub-areas as illustrated in FIG. 3).

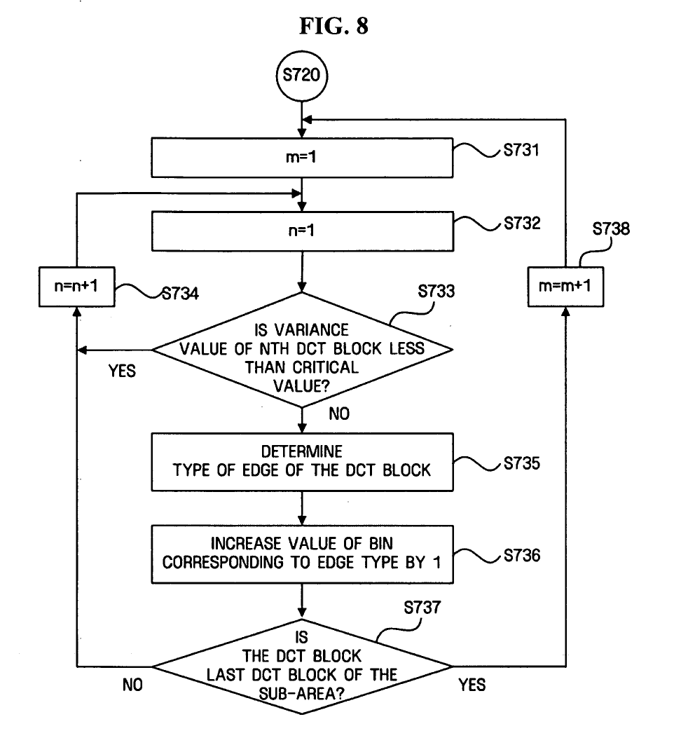

When the inverse-quantization process on the I frame is completed, the video-retrieval apparatus 200 generates the edge histogram according to the type of the edge included in the plurality of DCT blocks by I frames S730. Here, the edge-histogram generation by I frames is described in more detail with reference to FIG. 8. FIG. 8 is a flow chart specifically illustrating step S730 that generates the edge histogram of FIG. 7. For purposes of illustration, the apparatus 200 in FIG. 2 and the frame 300 shown in FIG. 3 are referred to with reference to FIG. 7.

The determination unit 260 determines whether each DCT block of each sub-area is an edge area, and generates the local edge histogram of the I frame. The determination unit 260 determines whether the first DCT block (hereinafter, called a “first DCT block”) 311 of a first sub-area 310 is an edge area S733. Here, the determination unit 260 determines whether the DCT block is an edge area according to whether the variance value of the first DCT block 311 is less than the first critical value. As a result, in the case where the variance of the first DCT block 311 is less than the first critical value (yes in S733), the determination unit 260 determines that the first DCT block 311 is an area that does include a smooth area (i.e., it is not an edge). In the case where the variance of first DCT block 311 is not less than the first critical value (no in S733), the determination unit 260 determines that the first DCT block 311 is an area that does not include a smooth area (i.e., it is an edge).

Then, the determination unit 260 determines whether the second DCT block 312 of the first sub-area 310 is an edge area S734, S732, and S733. As a result, where the variance value of the first DCT block 311 is greater than the first critical value (no in S733), the determination unit 260 determines that the first DCT block 311 is an edge area (i.e., an area that includes an edge).

If it is determined that the first DCT block 311 is an edge area, the determination unit 260 determines the type of the edge included in the first DCT block 311 S735. Specifically, the determination unit 260 determines that the type of the edge included in the first DCT block is a non-directional edge. Here, the determination unit 260 determines whether a non-directional edge is included based on the strength of AC_{0, 1} and AC_{1, 0} coefficients of the first DCT block 311. In other words, in the case where the strength of the edge is less than the second critical value, it is determined that the type of the edge included in the first DCT block 311 is a non-directional edge.

If the strength of the edge is greater than the second critical value, the determination unit 260 determines that the first DCT block 311 includes a directional edge. Here, the determination unit 260 determines what type of directional edge the first DCT block 311 includes depending on the ratio of two AC coefficients, especially AC_{0, 1} and AC_{1, 0}, among DCT coefficients of the first DCT block 311. For example, in the case where the ratio of two AC coefficients is close to 1, and the signs of the two AC coefficients are the same, it is determined that the first DCT block 311 includes a 45°-direction edge. In the case where the ratio of the two AC coefficients is close to 1, and signs of the two AC coefficients are different, it is determined that the first DCT block 311 includes a 135°-direction edge. In comparison, in the case where the ratio of the two AC coefficients is close to infinity, it is determined that the first DCT block 311 includes a vertical edge or a horizontal edge. In other words, in the case where R1 (Equation 2) is close to infinity, it is determined that the first DCT block 311 includes a horizontal edge, and in the case where R2 is close to infinity, it is determined that the first DCT block 311 includes a vertical edge.

Likewise, if the type of the edge included in the first DCT block 311 is determined S735, the edge-histogram-generation unit 270 increases the value of the bin that corresponds to the edge, among five bins included in the first sub-area 310 in the local-edge histogram of the first I frame S736. For example, in the case where it is determined that the first DCT block 311 includes a vertical edge, the edge-histogram-generation unit 270 increases the value of the bin corresponding to the vertical edge by 1, among five bins included in the first sub-area 310. In the case where it is determined that the first DCT block 311 includes a horizontal edge, the edge-histogram-generation unit 270 increases the value of the bin corresponding to the horizontal edge by 1, among five bins included in the first sub-area 310.

In the case where the aforementioned process is performed on all DCT blocks that constitute the first sub-area 310 (yes in S737), the determination unit 260 and the edge-histogram-generation unit 270 repeat the aforementioned processes S731 to S737 on the second sub-area 320, and complete the local-edge histogram of the I frame.

Further, in the case where the local-edge histogram of an I frame is completed, the determination unit 260 and the edge-histogram-generation unit 270 repeat the aforementioned processes S731 to S737 on all I frames detected from the query video, and complete the local-edge histogram for each I frame.

Further, in the case where the local-edge histogram on each I frame is completed, the key-frame-selection unit 280 retrieves a key frame based on the local-edge histogram of each I frame S740. Here, the key-frame-selection unit 280 selects the I frame, of which the edge histogram bin difference (EHBD) with the local edge histogram of the previous I frame is greater than the third critical value, as the key frame.

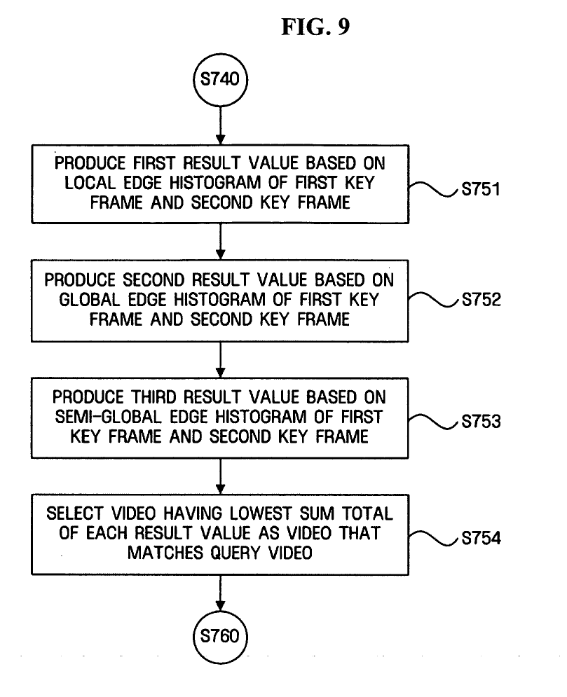

If a key frame is selected from the query video, the edge-histogram-generation unit 270 generates the global edge histogram and the semi-global edge histogram, respectively, based on the local edge histogram of each key frame. Then, the video-retrieval unit 290 retrieves the video that matches the query video by measuring the similarity rate between the first key frame and the key frame of the stored video (i.e., the second key frame S750). Here, the video-retrieval process is described in more detail with reference to FIG. 9.

FIG. 9 is a flow chart illustrating the video-retrieval process S750 in more detail. The video-retrieval unit 290 produces the Hausdorff distance between the first key frame and the second key frame in order to measure the similarity rate between the first key frame and the second key frame. For this, the video-retrieval-unit 290 produces the differential value of the bin at the same position, respectively, in the local-edge histogram of the first key frame and the second key frame, and then produces the first result value that is the sum total of the 80 differential values S751. The video-retrieval unit 290 produces the differential value of the bin at the same position in the global edge histogram of the first key frame and the second key frame, and then produces the second result value that is the sum total of 5 differential values S752. The video-retrieval unit 290 produces the differential value of the bin at the same position, respectively, in the semi-global edge histogram of the first key frame and the second key frame, and then produces the third result value that is the sum total of 65 differential values S753. The video-retrieval unit 290 produces the Hausdorff distance between the first key frame and the second key frame that is the sum total of the first result value, the second result value, and the third result value.

While not required in all aspects, the video-retrieval unit 290 can apply a predetermined weight to the second result value when summing each result value because the global histogram includes less number of bins compared to the local histogram and the semi-global histogram.

The video-retrieval unit 290 produces the Hausdorff distance on all second key frames of the stored videos, and selects one of the stored videos of the lowest result value (i.e., distance) as the video that matches the query video S754 using the sum total of the first result value, the second result value, and the third result values for the respective first and second key frames. If the video that matches the query video is retrieved by measuring the similarity rate, the video-retrieval apparatus 200 displays the video retrieved through the display unit 295 S760.

The video-retrieval method according to an aspect of the present invention requires less calculations as compared to the conventional technology. This method is described in more detail with reference to Tables 1 and 2. Here, Table 1 compares the performance of the video-retrieval method according to an exemplary embodiment of the present invention and the retrieval-performance of EMI and Gof-Gop, which are the conventional video-retrieval technologies.

TABLE 1
Comparison of Performance of Video-Retrieval Technologies

| | Query | Suggested EHB | EMI | GOF-GOP |
|---|---|---|---|---|
| NMRR | Ship | 0.6301 | 0.6895 | 0.6635 |
| | Soccer | 0.6354 | 0.4554 | 0.4635 |
| | News | 0.5351 | 0.5415 | 0.6558 |
| | Talk Show | 0.5052 | 0.6615 | 0.5969 |
| | Sponge | 0.5286 | 0.5514 | 0.6308 |
| | Stockholders' Club | 0.6357 | 0.7364 | 0.6512 |

| | | | |
|---|---|---|---|
| ANMRR | 0.5783 | 0.6059 | 0.6103 |

TABLE 2
Comparison of Amount of Calculations of Video-Retrieval
Technologies

| | | | | | | Average |
|---|---|---|---|---|---|---|
| | sample | EHB | EMI | GOFGOP | Efficiency | Efficiency |
| Key-Frame | news.mpg | 2,031 | 30,135 | x | 93.3% | 93.2% |
| Extraction | boat.mpg | 744 | 11,697 | | 93.7% | |
| Experiment | amplaza.mpg | 1,623 | 22,020 | | 92.6% | |
| DB Extraction | news.mpg | 7,140 | 110,889 | 175,204 | 93.6% | 93.7% |
| Experiment | boat.mpg | 2,775 | 43,593 | 69,312 | 93.6% | |
| | amplaza.mpg | 5,901 | 96,198 | 151,030 | 93.9% | |
| DB-Matching | news.mpg | 7,158 | 311,463 | 181,862 | 97.7% | 97.1% |
| Experiment | boat.mpg | 2,787 | 142,323 | 73,402 | 98.0% | |
| | amplaza.mpg | 5,961 | 212,088 | 157,223 | 97.2% | |

Normalized Modified Retrieval Rank (NMRR) and Average Normalized Modified Retrieval Rank (ANMRR) can be used as an index of the retrieval performance. Here, NMRR is an evaluation criterion for evaluating the retrieval efficiency in MPEG-7. The NMRR takes a value between 0 and 1; the lower the value the better the efficiency. ANMRR represents the average NMRR.

Referring to Table 1, the video-retrieval method according to the present embodiment of the present invention is similar to the conventional EMI and GofGop technologies in terms of retrieval performance. Further, referring to Table 2, in the case where a video is retrieved using the method of the present embodiment of the present invention, the amount of calculation is reduced by more than 90% compared to the methods of EMI and GofGop.

It should be understood by those of ordinary skill in the art that various replacements, modifications and changes may be made in the form and details without departing from the spirit and scope of the present invention as defined by the following claims. Therefore, it is to be appreciated that the above described embodiments are for purposes of illustration only and are not to be construed as limitations of the invention. For instance, while described in terms of using edge histograms, it is understood that other histograms (such as color histograms) can be further used in the comparison and/or key frame selection, and that each of the local, semi-global, and global edge histograms need not be used in all aspects of the invention.

According to the method and apparatus of the present invention, the amount of calculation needed for a video retrieval is reduced, and thus a video can be retrieved at high speed, which is advantageous.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A video-retrieval apparatus comprising:
an input unit that receives a sample video extracted from a predetermined video, the sample video including frames;
an edge-histogram-generation unit that generates an edge histogram for each of the frames according to type of edges that are included in discrete cosine transform (DCT) blocks of the frame, each frame being divided into a plurality of sub-areas and each sub-area having corresponding pluralities of the DCT blocks;
a key-frame-selection unit that selects one of the frames as a first key frame based on the generated edge histograms for the frames; and
a video-retrieval unit that retrieves a video from storage that matches the sample video by measuring a similarity rate between the first key frame and a second key frame included in the video selected from the storage.

2. The apparatus of claim 1, further comprising a frame-detection unit that detects I frames among the frames included in the sample video, and the first key frame is one of the I frames.

3. The apparatus of claim 1, further comprising a determination unit that, for each DCT block in each sub-area, determines the DCT block is an edge area when a variance value of the DCT block is greater than a critical value.

4. The apparatus of claim 3, wherein, for each DCT block,
the DCT block comprises DCT coefficients expressed as corresponding combinations of pixels that constitute the DCT block, and
the variance value is produced based on a plurality of AC coefficients among the DCT coefficients.

5. The apparatus of claim 4, wherein the determination unit determines the type of the edge included in each DCT block based on a ratio of a first one of the AC coefficient that corresponds to a horizontal element of the edge included in the DCT block, and a second one of the AC coefficients that corresponds to a vertical element of the edge included in the DCT block.

6. The apparatus of claim 5, wherein the determination unit determines, for each of the DCT blocks, the type of the edge included in the DCT block according to a size and a sign of the first AC coefficient and the second AC coefficient.

7. The apparatus of claim 1, wherein:
the edge-histogram-generation unit comprises:
a local-edge-histogram-generation unit that generates, for each of the sub-areas, a local edge histogram that includes edge distribution information for the sub-area;
a global-edge-histogram-generation unit that generates a global edge histogram that includes the edge distribution information for each frame; and
a semi-global edge-histogram-generation unit that generates, for each of a plurality of semi-global areas, a semi-global histogram that has the edge distribution information for the semi-global area, and
the semi-global areas include corresponding pluralities of the sub-areas grouped into predetermined units.

8. The apparatus of claim 7, wherein a difference between the local histogram of the first key frame and the local histogram of a previous frame is greater than a critical value.

9. The apparatus of claim 7, wherein:
the video-retrieval unit measures the similarity rate according a predetermined distance function, and
the distance function is a sum total of differences between the local edge histogram, the global edge histogram and the semi-global edge histogram of the first key frame, and a local edge histogram, a global edge histogram and a semi-global edge histogram of the second key frame.

10. The apparatus of claim 9, wherein a weight is applied to the distance function depending on a number of bins included in each edge histogram of the first key frame and the second key frame.

11. A video-retrieval method comprising:
receiving a sample video extracted from a predetermined video, the sample video including frames;
for each of the frames, generating an edge histogram according to type of edges that are included in discrete cosine transform (DCT) blocks of the frame, each of the frames being divided into a plurality of sub-areas and each of the sub-areas includes a corresponding plurality of the DCT blocks;
selecting one of the frames as a first key frame based on the generated edge histograms for the frames; and
retrieving a video from storage that matches the sample video by measuring a similarity rate between the first key frame and a second key frame for the video in the storage.

12. The method of claim 11, wherein the receiving comprises extracting an I frame among the frames included in the sample video.

13. The method of claim 11, further comprising determining, for each DCT block, the DCT block as an edge area when a variance value of the DCT block is greater than a critical value.

14. The method of claim 13, wherein:
each DCT block comprises DCT coefficients expressed as corresponding combinations of pixels that constitute the DCT block, and
the variance value is produced based on a plurality of AC coefficients among the DCT coefficients.

15. The method of claim 14, wherein the generating comprises determining the type of the edge included in the DCT block based on a ratio of a first one of the AC coefficients that corresponds to a horizontal element of the edge included in the DCT block, and a second one of the AC coefficients that corresponds to a vertical element of the edge included in the DCT block.

16. The method of claim 15, wherein the determining comprises determining, for each of the DCT blocks, the type of the edge included in the DCT block according to a size and a sign of the first AC coefficient and the second AC coefficient.

17. The method of claim 11, wherein the generating comprises, for each frame,
generating, for each of the sub-areas, a local edge histogram that includes edge distribution information for the sub-area;
generating a global edge histogram that includes the edge distribution information for the frame;
generating, for each of a plurality of semi-global areas, a semi-global histogram that has the edge distribution information for the semi-global area, and
the semi-global areas comprise corresponding pluralities of the sub-areas grouped into predetermined units.

18. The method of claim 17, wherein a difference between the local histogram of the first key frame and a local histogram of a previous frame is greater than a critical value.

19. The method of claim 17, wherein:
the retrieving comprises measuring a similarity rate according a predetermined distance function, and
the distance function is a sum total of differences between the local edge histogram, the global edge histogram and the semi-global edge histogram of the first key frame, and a local edge histogram, a global edge histogram and a semi-global edge histogram of the second key frame.

20. The method of claim 19, further comprising applying a weight to the distance function depending on a number of bins included in each edge histogram of the first key frame and the second key frame.

21. A video-comparison system for comparing a first video with a second video, comprising:
an edge-histogram-generation unit that receives the first video after the first video is divided into a plurality of sub-areas, determines within each sub-area a type of edge for a portion of an image in each of a plurality of discrete cosine transform (DCT) blocks of the sub-area, and generates an edge histogram for the frame according to the types of edges determined to be included in each sub-area;
a key-frame-selection unit that selects one of the frames of the first video as a first key frame based on the generated edge histogram; and
a video-comparison unit that correlates the second video having a second key frame with the first video by determining a similarity between an edge histogram of the second key frame and the generated edge histogram of the first key frame.

22. The video-comparison system of claim 21, wherein, for each DCT block, the edge-histogram-generation unit determines the type of edge selectable between a horizontal edge, a vertical edge, and a non-vertical and non-horizontal edge.

23. The video-comparison system of claim 22, wherein:
for each sub-area, the edge-histogram-generation unit generates a first bin relating to a number of the horizontal edges in the DCT blocks of the sub-area, a second bin relating to a number of the vertical edges in the DCT blocks of the sub-area, and a third bin relating to a number of the non-vertical and non-horizontal edges in the DCT blocks of the sub-area, and
the edge-histogram-generation unit generates the edge histogram for the frame using the first, second, and third bins.

24. The video-comparison system of claim 23, wherein the edge-histogram-generation unit generates a local edge histogram for each sub-area in the frame using the first, second, and third bins using the DCT blocks within the corresponding sub-area.

25. The video-comparison system of claim 23, wherein the edge-histogram-generation unit:
organizes each sub-area as part of one of a plurality of semi-global areas having specific locations within the frame, and
generates a semi-global edge histogram for each semi-global area in the frame using the first, second, and third bins for the DCT blocks within the sub-areas included the semi-global area.

26. The video-comparison system of claim 23, wherein the edge-histogram-generation unit generates a global edge histogram for the entire frame using the first, second, and third bins for the DCT blocks within the sub-areas included the frame.

27. The video-comparison system of claim 24, wherein the edge-histogram-generation unit:
organizes each sub-area as part of one of a plurality of semi-global areas having specific locations within the frame, and
generates a semi-global edge histogram for each semi-global area in the frame using the first, second, and third bins for the DCT blocks within the sub-areas included the semi-global area.

28. The video-comparison system of claim 27, wherein the edge-histogram-generation unit generates a global edge histogram for the entire frame using the first, second, and third bins for the DCT blocks within the sub-areas included the frame.

29. The video-comparison system of claim 21, wherein:
each frame is partitioned into 16 sub-areas,
each sub-area is partitioned into a plurality of 8×8 DCT blocks,
each DCT block has a DCT coefficient comprising a linear combination of all pixels within the DCT block calculated according to the following equation:
$$A {C}_{u , v} = \frac{1}{4} {C}_{u} {C}_{v} {\sum }_{i = 0}^{7} {\sum }_{j = 0}^{7} cos \frac{( 2 i + 1 ) u π}{16} cos \frac{( 2 j + 1 ) v π}{16} f ( i , j )$$
$${C}_{u} , {C}_{V} = [ \begin{matrix}\sqrt{\frac{1}{2}} , & for u , v = 0 \\ 1 , & otherwise\end{matrix}$$
AC_{0, 0} is a coefficient of a DC element and is an average brightness of the DCT block,
AC_{0, 1} to AC_{7, 7} are AC elements that have a certain direction and a certain rate of change and reflect a change in a gray level value,
f(i,j) represents a pixel value at location i,j of the DCT block, and
the edge-histogram-generation unit uses one or more of DC and/or AC elements to determine the type of edge in each DCT block.

30. The video-comparison system of claim 29, wherein
AC_{0, 1} indicates a difference in a horizontal direction between a left side and a right side of the DCT block,
AC_{1, 0} indicates a difference in a vertical direction between an upper side and a lower side of the DCT block,
the edge-histogram-generation unit uses the coefficient AC_{0, 1} to detect an edge element in a horizontal direction, and
the edge-histogram-generation unit uses the coefficient AC_{1, 0} to detect an edge element in the vertical direction.

31. The video-comparison system of claim 29, wherein the edge-histogram-generation unit uses a ratio of the coefficient AC_{0, 1} to the coefficient AC_{1, 0} to detect an non-vertical and non-horizontal edge element.

32. The video-comparison system of claim 29, wherein:
the edge-histogram-generation unit detects a direction of the edge element relative to the horizontal direction and the vertical direction according to a relationship between R1 and R2,
$$R 1 = \vert \frac{A {C}_{0 , 1}}{A {C}_{1 , 0}} \vert , \\ R 2 = \vert \frac{A {C}_{1 , 0}}{A {C}_{0 , 1}} \vert .$$

33. The video-comparison system of claim 23, wherein the key-frame-selection unit that selects one of the frames of the first video as the first key frame by comparing the first, second, and third bins for each frame of the first video with the first, second, and third bins of the remaining frames, and selecting as the first key frame the frame having a greatest difference in the edge histogram as compared to the remaining frames.

34. The video-comparison system of claim 24, wherein the key-frame-selection unit that selects one of the frames of the first video as the first key frame by comparing the first, second, and third bins for the local edge histogram at a specific location in each frame of the first video with the first, second, and third bins for the local edge histograms at the specific location of the remaining frames, and selecting as the first key frame the frame having a greatest difference in the local edge histogram at the specific location as compared to the remaining frames.

35. The video-comparison system of claim 23, wherein the video-comparison unit determines a difference between an edge histogram of the second key frame and the edge histogram of the first key frame, and if the difference is below a threshold, determines that the first video is the same as the second video.

36. The video-comparison system of claim 24, wherein the video-comparison unit determines a difference between the local edge histogram at a specific location of the first key frame and a local edge histogram at the specific location of the second key frame, and if the difference is below a threshold, determines that the first video is the same as the second video.
